(19) United States
(12) Patent Application Publication
(10) Pub. No.: US 2007/0217768 A1
(43) Pub. Date: Sep. 20, 2007

(54) Optical disc image forming apparatus

(75) Inventor: Shinichi Nakata, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi-LG Data Storage, Inc., Tokyo (JP)

(21) Appl. No.: 11/543,702

(22) Filed: Oct. 4, 2006

(30) Foreign Application Priority Data
Mar. 10, 2006 (JP) 2006-065295

(51) Int. Cl. H04N 5/00

(52) U.S. Cl. 386/126

(57) ABSTRACT

When an image is formed on an optical disc, a pickup is moved by a pitch S in the radial direction of the optical disc together with a slider supporting the pickup. An objective lens within the pickup is shifted by a predetermined shift amount L by an actuator to emit a laser beam. The temperature in the vicinity of the pickup is detected by a temperature sensor. If the detected temperature has increased as much as, or more than, a threshold ΔTth relative to the temperature prior to the beginning of the formation of an image, a movement setting unit sets the slider movement pitch S and the objective lens shift amount L to small values so as to reduce the maximum drive current applied to the actuator.

### CLAIM OF PRIORITY

The present application claims priority from Japanese application serial no. JP 2006-065295, filed on Mar. 10, 2006, the content of which is hereby incorporated by reference into this application.

### BACKGROUND OF THE INVENTION

(1) Field of the Invention

The present invention relates to an optical disc image forming apparatus for forming a visible image associated with image data by irradiating an optical disc with a laser beam in accordance with image data.

(2) Description of the Related Art

An optical disc image forming apparatus is designed to irradiate with a laser beam an optical disc having a heat-sensitive layer in accordance with given image data (e.g., graphics and text) so as to form a corresponding visible image on the surface of the optical disc opposite to the information recording surface (so-called the “label surface”). At this time, image data is given as data specific to each of the tracks on the disk. An optical pickup emits a laser beam having an intensity according to the image data a position in the predetermined radial direction and rotational angle of the optical disc. The optical pickup is moved in the radial direction of the optical disc at a predetermined track pitch because tracking control guide grooves are not present on the label surface of the optical disc. To transform graphics and text into a visible image, the same data is normally written to a plurality of tracks repeatedly.

An optical pickup movement mechanism in the optical disc image forming apparatus moves the pickup in two steps. First, a slider supporting the entire optical pickup is coarsely moved in the radial direction of the optical disc. Next, an objective lens is shifted in the radial direction of the optical disc by an actuator so as to control the laser beam irradiation position. At this time, the lack of guide grooves makes it impossible to apply feedback tracking control. As a result, the radial positioning accuracy is affected by the performance and accuracy of the movement mechanism, which in turn affects the quality of image formed.

In relation to this problem, Japanese Patent Laid-Open No. 2005-353219 describes a technique intended to achieve precise control in the radial direction of the optical disc with an accuracy equal to or greater than the traverse feed at which the optical pickup is moved. This technique determines a next recording position by first detecting whether the recording layer at the position accessed by the optical pickup is recorded or not and then by searching for the inner perimeter edge of the unrecorded area to be recorded next.

It should be noted that the technique, given in Japanese Patent Laid-Open No. 11-232658 as a related technique, is intended to prevent hunting (malfunction as a result of overfeeding of the pickup) in a pickup feed system operable to record and reproduce information rather than form an image. Here, a traverse motor adapted to move the pickup is supplied with a drive voltage from when the detected lens shift amount exceeds the predetermined threshold (dead band). According to the document, the technique makes it possible to set the threshold at which the drive voltage begins to be applied at will, thus preventing hunting resulting from overfeeding even in the event of a change in frictional load of the mechanical portion due to individual variation or temperature change.

### SUMMARY OF THE INVENTION

The temperature rise in an optical disc image forming apparatus is greater during image recording than in an optical disc apparatus for recording and reproducing information, possibly degrading the characteristics of the optical pickup components and damaging the parts. Among possible degradations and damage that may occur are cracks in the objective lens and degraded emission characteristics of the laser diode which is the light source. Because these defects will lead to deteriorated recording performance, the temperature rise must be kept within an acceptable level. One of the major contributors to temperature rise is an excessive drive current applied to the actuator adapted to shift the lens so as to impart a large displacement of the lens.

In Japanese Patent Laid-Open No. 2005-353219, no mention is made with respect to the problematic temperature rise of the optical pickup. The technique in Japanese Patent Laid-Open No. 11-232658, on the other hand, is designed to prevent hunting for stable feed of the optical pickup even in the event of a change in the ambient temperature. As a result, reduction of the temperature rise is not considered.

Here, the optical disc image forming apparatus differs in control system from the optical disc apparatus for recording and reproducing information (the category under which the apparatus described in Japanese Patent Laid-Open No. 11-232658 falls). That is, while the optical disc apparatus for recording and reproducing information can apply feedback control to the slider movement and the objective lens shifting using guide grooves, the optical disc image forming apparatus employs open loop control rather than feedback control because of the lack of guide grooves on the optical disc. This difference is linked to the temperature rise.

Feedback control detects the lens displacement (lens shift amount) based on a tracking error signal, thus allowing a drive voltage to be applied to the slider if the detected displacement exceeds the predetermined threshold. This control scheme also causes the slider to constantly follow the desired track position, thus allowing to maintain the lens shift amount at nearly zero as necessary. Feedback control, therefore, is capable of operating the actuator in a relatively small range of displacements.

However, the optical disc image forming apparatus based on open loop control is unable to detect the shift amount of the lens in operation using the tracking error signal. As a result, the apparatus is incapable of causing the slider to track the desired track position on the disk or maintaining the lens shift amount at nearly zero. Therefore, the actuator under open loop control must operate in a relatively large range of displacements, thus making the apparatus vulnerable to temperature rise.

It is an object of the present invention to reduce the temperature rise in the optical disc image forming apparatus and thus prevent the degradation of the characteristics of the optical pickup components and damage to the parts.

The present invention is an optical disc image forming apparatus for forming a visible image associated with image data by irradiating an optical disc with a laser beam. The optical disc image forming apparatus is provided with a spindle motor adapted to rotate the optical disc, a laser beam source adapted to generate a laser beam for the image data, and an objective lens adapted to irradiate the optical disc with a laser beam. The apparatus is further provided with a pickup having an actuator adapted to shift the objective lens in the radial direction of the optical disc, a stepping motor adapted to move the slider supporting the pickup in the radial direction of the optical disc, a temperature sensor adapted to detect temperature in the vicinity of the pickup, and a movement control unit adapted to control the operation of the stepping motor and the actuator. The movement control unit changes a slider movement pitch and an objective lens shift amount in response to the temperature detected by the temperature sensor. Here, if the temperature detected by the temperature sensor has increased as much as, or more than, a threshold from the temperature prior to the beginning of the formation of an image, the movement control unit sets the slider movement pitch and the objective lens shift amount to small values. When setting the objective lens shift amount to a small value the movement control unit reduces the maximum drive current applied to the actuator.

The present invention suppresses the temperature rise in an optical disc image forming apparatus, thus preventing the degradation of the characteristics of the optical pickup components and ensuring stable formation of an excellent image.

### BRIEF DESCRIPTION OF THE DRAWINGS

FIG. 1 is a block diagram showing an embodiment of an optical disc image forming apparatus according to the present invention;

FIG. 2 is a view describing the basic operation of a slider and an objective lens;

FIGS. 3A and 3B are views showing how a slider movement pitch and a lens shift amount are changed during temperature rise;

FIG. 4 is a graph showing the temperature increase around a pickup resulting from the change in the lens shift amount; and

FIG. 5 is a view showing a flowchart of the image forming process.

### DETAILED DESCRIPTION OF THE PREFERRED EMBODIMENTS

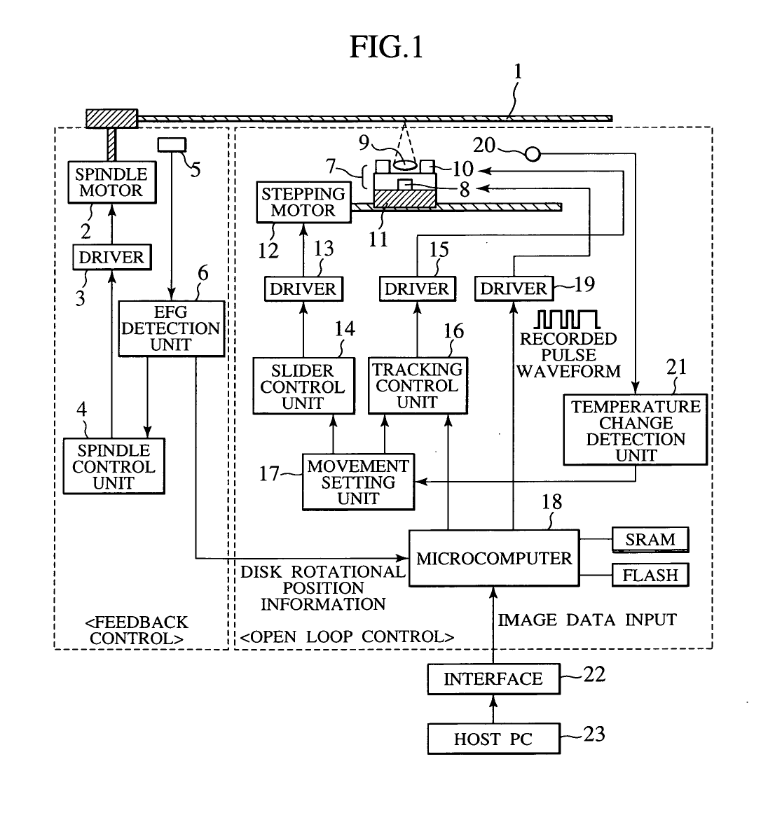

FIG. 1 is a block diagram showing an embodiment of an optical disc image forming apparatus according to the present invention. The apparatus of the present embodiment rotates an optical disc 1 loaded therein with a spindle motor 2 and irradiates with a laser beam from a pickup 7 an image forming surface of the optical disc 1 (label surface) to record a visible image (e.g., graphics and text). The pickup 7 moves together with a slider 11 which supports the pickup 7 in the radial direction of the optical disc as a result of the rotation of a stepping motor 12.

The spindle motor 2 is driven by a driver 3. A spindle control unit 4 controls the rotation of the spindle motor 2 based on rotational speed and rotational position (rotational angle) signals detected by a photo encoder 5 and an EFG detection unit 6. This control is feedback control.

The stepping motor 12 is driven by a driver 13. A slider control unit 14 controls the stepping motor 12 so as to move the slider 11 at a predetermined pitch in the radial direction of the optical disc.

The pickup 7 has a laser diode (LD) 8 which is the laser beam source, an objective lens 9 adapted to irradiate the optical disc with a laser beam, and an actuator 10 adapted to shift the objective lens 9 in the radial direction of the optical disc. Although the pickup 7 has a focus control mechanism, optical detector and other devices in addition to the above, the description thereof is omitted here. Driven by a driver 15, the actuator 10 passes a drive current through a moving coil to shift the objective lens 9. A tracking control unit 16 shifts the objective lens 9 at a predetermined pitch (track pitch) so as to allow the lens to take the desired track position. It should be noted, however, that this control is open loop control as no positional information in the radial direction of the disk is used.

A microcomputer 18 receives image data from a host PC 23 via an interface 22, generates a recording pulse signal for the image data and supplies the signal to the laser diode (LD) 8 via a driver 19. At this time, the microcomputer 18 supplies the signal synchronously with the rotational position (rotational angle) of the optical disc and the radial position (track position) of the pickup to form a desired two-dimensional visible image on the label surface of the optical disc.

In the present embodiment, a temperature sensor 20 is provided in the vicinity of the pickup 7 so that the temperature rise is detected by a temperature change detection unit 21. The temperature sensor 20 may be provided inside the pickup 7. If the temperature changes more than the predetermined value, a movement setting unit 17 changes the movement settings of the slider control unit 14 and the tracking control unit 16. This ensures optimal control of the slider movement pitch and the lens shift amount in accordance with the ambient temperature.

The temperature rise in an optical disc image forming apparatus is generally large. The contributor to temperature rise is heat generated by a laser emission unit, the actuator, the spindle motor, the stepping motor and a control circuit. The temperature rise around the pickup is particularly problematic as it is directly linked to the recording performance. In the present embodiment, the current applied to the actuator is reduced to keep down the temperature rise around the pickup. Therefore, if the temperature rises more than the predetermined value, the present embodiment reduces the slider movement pitch and the lens shift amount so as to reduce the current applied to the actuator and thereby prevent heat generation. The smaller the slider movement pitch, the longer the total image forming time. As a result, when the temperature rise falls below the predetermined value, the present embodiment restores the slider movement pitch and the lens shift amount to normal, thus reducing the image forming time.

The temperature sensor 20 detects the temperatures in proximity to the pickup at the beginning of and during recording. The slider movement pitch is reduced if the temperature rise is equal to or greater than the threshold, and is restored to normal when the temperature rise falls below the threshold. The lens shift amount is varied together with the slider movement pitch so that the lens shift amount becomes smaller as the movement pitch becomes smaller.

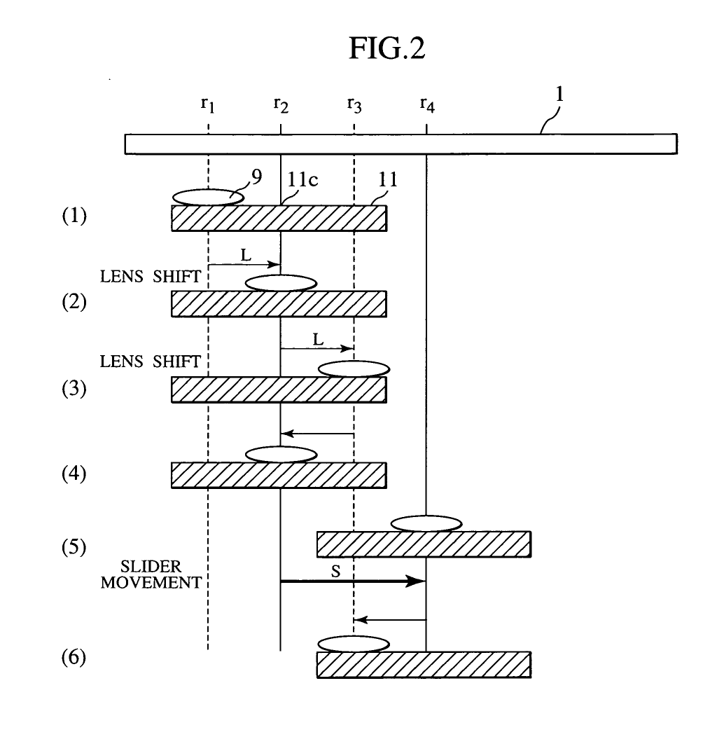

FIG. 2 is a view describing an example of the basic operation of the slider and the objective lens in the optical disc image forming apparatus. This figure illustrates, in the order of steps, the positions to which the slider 11 and the objective lens 9 move in the radial direction of the optical disc 1. First, the slider 11 moves in the radial direction of the optical disc at a pitch S as the slider is driven by the stepping motor 12. This pitch S is called the slider movement pitch. This causes, for example, a center 11c of the slider 11 to move sequentially to radial positions r₂, r₄ and so on (steps (1) and (5)).

On the other hand, the objective lens 9 moves (is shifted) by a width L to the left or right relative to the slider 11 (steps (1), (2) and (3)) as the lens is driven by the actuator 10. At this time, the position of the objective lens 9 at the midpoint of the actuator (where no drive current is applied) is aligned with the center 11c of the slider 11. This shift amount L is called the lens shift amount. Then, a laser beam is irradiated onto a plurality of tracks included within this lens shift amount to form an image. In this case, the track pitch is determined separately from the required image performance (e.g., resolution). In order to allow the objective lens 9 to continuously scan over the disk without any gap, one needs only to set S=2L.

At the completion of the shifting of the objective lens by ±L (from r₁ to r₃ in the figure) on the slider, the slider moves from a position r₂ to a position r₄ (step (5)). From this moment onward, the slider 11 and the objective lens 9 move alternately. This alternate movement is repeated until there is no more image data. It should be noted that the slider movement is followed by the return motion of the objective lens. FIG. 2 shows a case in which the objective lens returns to the center of the slider (step (4)). The basic operation of the slider and the objective lens is not limited thereto, and various other combinations are also possible.

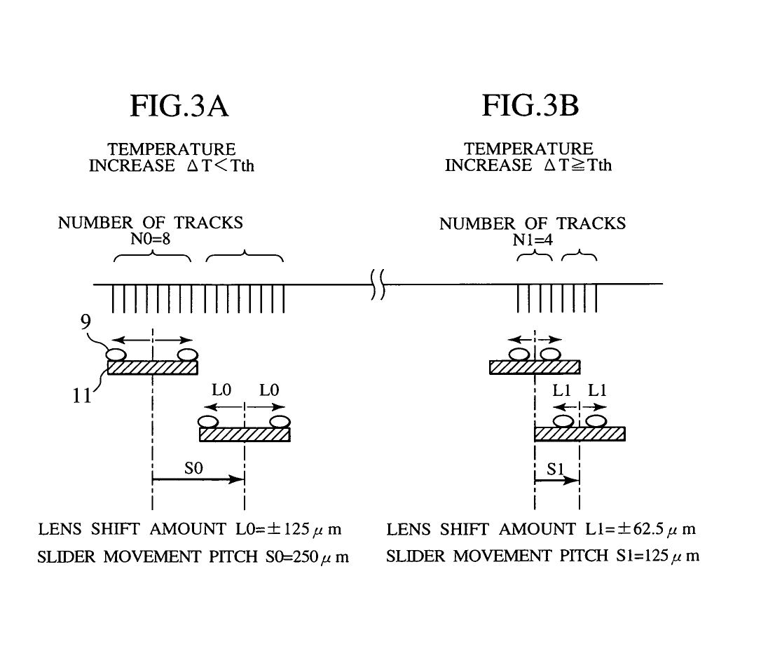

FIGS. 3A and 3B are views showing an example of how the slider movement pitch and the lens shift amount are changed in response to a temperature rise. Assuming an initial temperature and a temperature during recording to be T0 and T1, respectively, a temperature increase ΔT=T1−T0 is determined. The slider movement pitch and the lens shift amount are changed if the temperature increase ΔT is equal to or greater than a threshold ΔTth (e.g., 10° C.).

FIG. 3A shows a case in which the temperature increase is small (ΔT<ΔTth). In this case, the slider movement pitch S is set to a normal value (large value), for example, S0=250 μm. A lens shift amount L0 is accordingly set, namely, L0=±125 μm. Data is recorded, for example, to eight tracks (N0=8; referred to as specified track count) which are included within the lens shift amount. In this case, the lens shift amount L0 is large, thus causing the drive current applied to the actuator 10 to increase almost proportionately thereto.

FIG. 3B shows a case in which the temperature increase is large (ΔT≧ΔTth). In this case, the slider movement pitch S is set to a small value. That is, the pitch is changed, for example, to half the value set in the above case, which is S1=125 μm. A lens shift amount L1 is accordingly set, namely, L1=±62.5 μm. Data is recorded, for example, to four tracks (specified track count N1=4) which are included within the lens shift amount. In this case, the lens shift amount L1 is small and only half the shift amount set in the above case, thus causing the drive current applied to the actuator 10 to drop to roughly half the level set in the above case. This reduces heat generation by the actuator 10, thus suppressing the temperature rise of the pickup and the surrounding area thereof.

While the case of changing the slider movement pitch S and the lens shift amount L in two steps was described in FIGS. 3A and 3B, the pitch and the shift amount can be changed in a plurality of steps by providing the plurality of temperature rise thresholds ΔTth. For instance, further smaller pitch S2=62.5 μm and shift amount L2=±31.3 μm can be added. Alternatively, if the temperature increase resulting from the further smaller pitch S and shift amount L exceeds the threshold ΔTth, one may reduce the pitch S and the shift amount L still further.

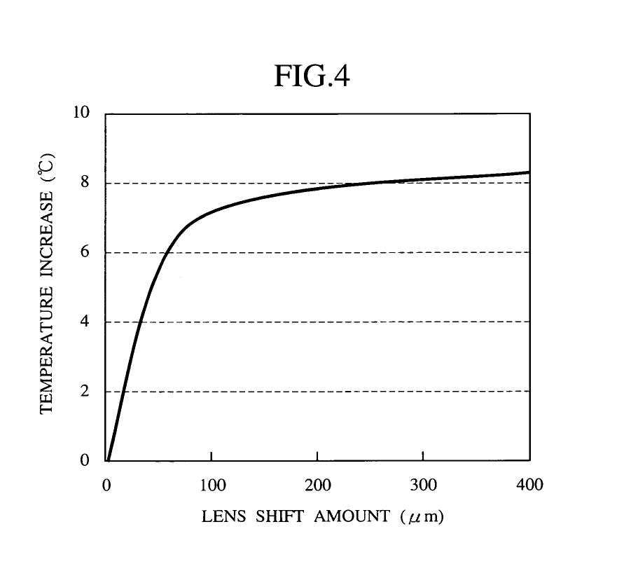

FIG. 4 is a graph showing the temperature increase measured around the pickup when the lens was shifted by the actuator. The horizontal and vertical axes of the graph represent the lens shift amount and the temperature increase as compared with the temperature before the lens was shifted, respectively. As can be observed from the graph, the current applied to the actuator is reduced by reducing the lens shift amount, which in turn suppresses the temperature rise. It should be noted that the values shown here are given by way of example. It is needless to say that the magnitude of temperature rise is dependent on the structure of the apparatus around the pickup.

The present embodiment suppresses the temperature rise inside the pickup, thus preventing the degradation of the pickup components and contributing to stable formation of an excellent image.

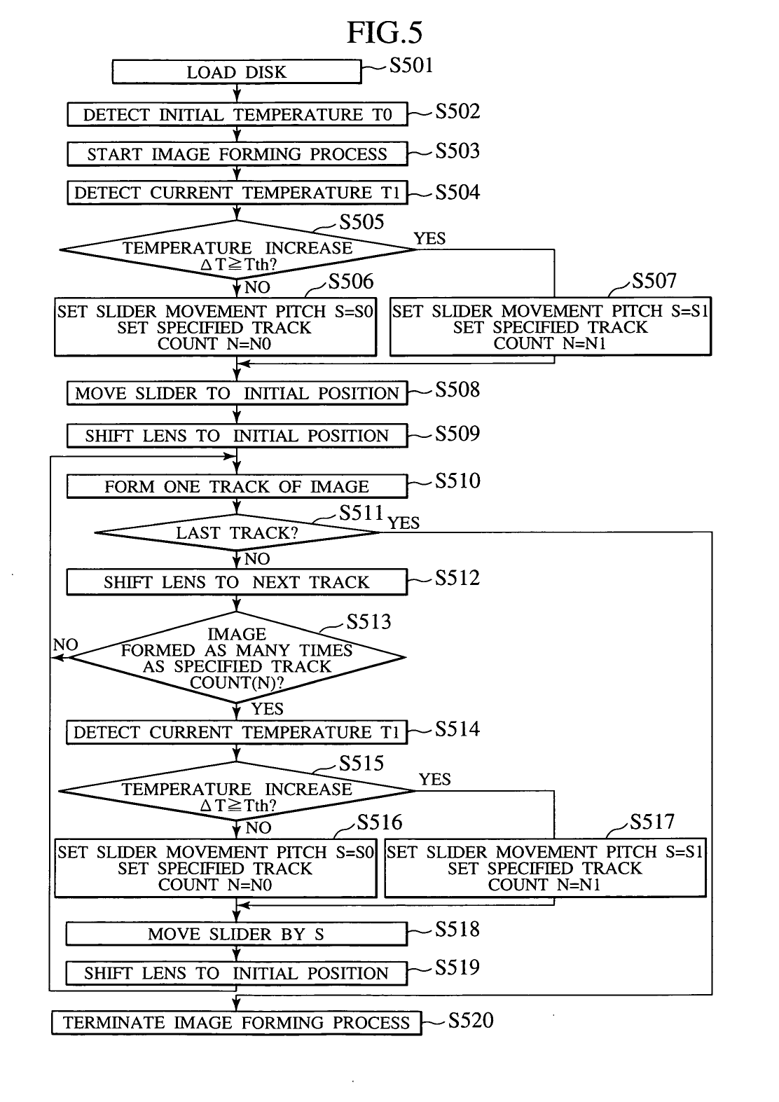

FIG. 5 is a view showing a flowchart of the image forming process in the optical disc image forming apparatus of the present embodiment. The image forming process flow will be described with reference thereto.

As the optical disc is loaded (S501), the temperature sensor 20 measures the temperature around the pickup prior to the image forming operation. The measured temperature is stored in the temperature change detection unit 21 as the initial temperature T0 (S502). Upon receiving an instruction to start the image formation, the microcomputer 18 receives image data from the host PC 23 to prepare for the start of recording (S503). First, the temperature sensor 20 measures the current temperature T1. The temperature change detection unit 21 determines the temperature increase ΔT (=T1−T0) relative to the initial temperature T0 and determines whether the temperature increase ΔT is equal to or greater than the threshold ΔTth (e.g., 10° C.) (S505).

When the temperature increase is smaller than the threshold or ΔT<ΔTth (No in S505), the movement setting unit 17 sets the slider movement pitch S to S0 (e.g., 250 μm). At the same time, the specified track count N, which is the number of tracks onto which data is to be recorded per slider position, is set to N0 (e.g., eight tracks) based on a track pitch Tp that has been separately determined (S506).

If the temperature increase is equal to or greater than the threshold or ΔT≧ΔTth (Yes in S505), the movement setting unit 17 sets the slider movement pitch S to S1 (e.g., 125 μm). The movement setting unit 17 accordingly sets the specified track count N, which is the number of tracks onto which data is to be recorded per slider position, to N1 (e.g., four tracks) (S507).

The slider control unit 14 moves the slider 11 to an initial position (S508). Here, the initial position is adjusted in accordance with the slider movement pitch S and the specified track count N. The tracking control unit 16 shifts the objective lens 9 to an initial position (S509). The initial position is determined by the specified track count N. As the initial position, one needs only to select a position that is, for example, Tp×N/2 away from the midpoint of the actuator 10.

Next, image data signal is recorded onto one track to form an image (S510). A judgment is made as to whether the image data has been recorded onto the last track (S511). If yes, the image forming process is terminated (S520). If no, the lens is shifted by the track pitch Tp to a next track (S512). Then, a judgment is made as to whether the image data has been recorded as many times as the specified track count N at the current slider position (S513). If the number of times the image data has been recorded is smaller than the specified track count N, the process returns to S510 where the image data is recorded onto one track, after which the aforementioned steps will be repeated.

If the number of times the data has been recorded is equal to the specified track count N in step S513, the slider will be moved to a next position. Before the slider is moved, however, the slider movement condition is readjusted. First, the current temperature T1 is measured (S514). Then, the temperature increase ΔT (=T1−T0) relative to the initial temperature T0 is determined. Finally, a judgment is made as to whether the temperature increase ΔT is equal to or greater than the threshold ΔTth (S515).

When the temperature increase is smaller than the threshold or ΔT<ΔTth, the movement setting unit 17 sets the slider movement pitch S to S0. At the same time, the movement setting unit 17 sets the specified track count N, which is the number of tracks onto which data is to be recorded per slider position, to N0 (S516). If the temperature increase is equal to or greater than the threshold or ΔT≧ΔTth, the movement setting unit 17 sets the slider movement pitch S to S1. At the same time, the movement setting unit 17 sets the specified track count N to N1 (S517). These settings are the same as those in steps S506 and S507.

The slider control unit 14 moves the slider 11 by the pitch S (S518). The tracking control unit 16 shifts the objective lens 9 to the initial position (S519). Then, the process returns to S510 where the image data is recorded onto one track, after which the aforementioned steps will be repeated until the recording of all the image data is complete.

According to the aforementioned flowchart, the movement can be set in precise response to the temperature rise during the image formation process. First, if the temperature increase equal to or greater than the threshold is already observed at the beginning of the image formation process, the slider movement pitch S is set to a small value as the initial setting. The temperature rises gradually during the recording in the course of formation of an image over the entire disk surface. According to the aforementioned flowchart, however, every time the slider moves, the temperature rise is verified. This makes it possible to adjust the slider movement condition frequently. Further, if the temperature increase falls below the threshold as a result of the adjustment of the slider movement condition, the movement condition is set back to its original value (larger movement pitch), thus reducing the image forming time.

While the above embodiment suppresses the temperature rise by reducing the lens shift amount as a result of changing the slider movement pitch S and the associated specified track count N, the temperature rise can be suppressed in different manners. For example, the actuator drive current is determined in advance that corresponds to the lens shift amount. Then, the actuator drive current is directly detected. If the drive current exceeds the threshold, the slider is moved to a next position. As a result, if the temperature rises, the drive current threshold is changed (the maximum drive current is reduced). This makes it possible to suppress the temperature rise.

The above embodiment determines the temperature increase relative to the temperature prior to the beginning of the recording following the disk loading (initial temperature T0) as the reference temperature to judge whether any temperature rise has taken place. The reference temperature is not limited thereto, and various other temperatures can be used as appropriate as the reference temperature in accordance with the sequence of operations of the apparatus. Further, the slider movement condition may be changed by judging whether the current temperature T1 exceeds a permissible temperature Tth (e.g., 50° C.) rather than whether the temperature variation exceeds the threshold.

What is claimed is:

1. An optical disc image forming apparatus for forming a visible image associated with image data by irradiating an optical disc with a laser beam, the apparatus comprising:
a spindle motor adapted to rotate the optical disc;
a pickup having a laser beam source adapted to generate a laser beam for the image data, an objective lens adapted to irradiate the optical disc with a laser beam, and an actuator adapted to shift the objective lens in the radial direction of the optical disc;
a stepping motor adapted to move a slider supporting the pickup in the radial direction of the optical disc;
a temperature sensor adapted to detect temperature in the vicinity of the pickup; and
a movement control unit adapted to control the operation of the stepping motor and the actuator;
wherein the movement control unit changes a movement pitch of the slider and a shift amount of the objective lens in response to a temperature detected by the temperature sensor.

2. The optical disc image forming apparatus of claim 1, wherein
the movement control unit changes the slider movement pitch and the objective lens shift amount in response to the detected temperature every time the slider is moved by the stepping motor.

3. The optical disc image forming apparatus of claim 1, wherein
if the temperature detected by the temperature sensor has increased as much as, or more than, a threshold relative to the temperature prior to the beginning of the formation of an image, the movement control unit sets the slider movement pitch and the objective lens shift amount to small values.

4. The optical disc image forming apparatus of claim 3, wherein
when setting the objective lens shift amount to a small value, the movement control unit reduces the maximum drive current applied to the actuator.

5. An optical disc image forming apparatus for forming a visible image associated with image data by irradiating an optical disc with a laser beam in accordance with image data, the apparatus comprising:
a spindle motor adapted to rotate the optical disc;
a pickup having a laser beam source adapted to generate a laser beam for the image data, an objective lens adapted to irradiate the optical disc with a laser beam, and an actuator adapted to shift the objective lens in the radial direction of the optical disc;
a stepping motor adapted to move a slider supporting the pickup in the radial direction of the optical disc;
a temperature sensor adapted to detect the temperature in the vicinity of the pickup; and
a movement control unit adapted to control the operation of the stepping motor and the actuator;
wherein the movement control unit reduces the maximum drive current applied to the actuator if the temperature detected by the temperature sensor is equal to or greater than a predetermined temperature.
